(19) United States
(12) Patent Application Publication
(10) Pub. No.: US 2004/0042527 A1
(43) Pub. Date: Mar. 4, 2004

(54) Device for determining the temperature of a medium flowing through a duct

(75) Inventors: Volker Block, Bretten (DE); Bernd Robin, Kraichtal (DE); Alfred Suss, Bretten (DE)

Correspondence Address: AKERMAN SENTERFITT, P.O. BOX 3188, WEST PALM BEACH, FL, 33402-3188, US

(73) Assignee: E.G.O. Elektro-Geraetebau GmbH, Oberderdingen (DE)

(21) Appl. No.: 10/648,896

(22) Filed: Aug. 27, 2003

(30) Foreign Application Priority Data
Aug. 28, 2002 (DE) DE 102 40 590.5

(51) Int. Cl. G01K 17/00

(52) U.S. Cl. 374/29

(57) ABSTRACT

A device for determining the temperature of a medium flowing through a duct has a probe body with a base member from which elongated probe arms project and extending in the manner of a curtain or grid through the duct. A temperature sensor is provided on the probe body. As a result of the probe arms extending in planar distributed manner over the duct cross-section, there is a type of planar, integral temperature determination with temperature averaging. This averaged temperature is measured with the temperature sensor. Thus, local medium temperature variations cannot falsify the result of the overall temperature.

### FIELD OF APPLICATION AND PRIOR ART

The invention relates to a device for determining the temperature of a medium flowing through a duct and an arrangement of such a duct with such a device.

It can e.g. be a device for determining the temperature of heated air or air to be heated, which is passed through a duct. It is of great importance to measure a temperature of a medium, which may in certain circumstances be eddied up and consequently has no uniform temperature distribution and which is in principle neither affected by particularly hot, nor particularly cold points. In many cases a medium flows either with a constant or variable temperature profile over the cross-section through a duct. On fitting a temperature sensor in the duct it is not possible to precisely forecast whether an unfavourable location for the measurement has not been chosen.

An attempt has in part been made in the prior art through the provision of several or even a plurality of temperature sensors in the duct to obtain a simultaneous or planar distributed temperature determination, but the effort and expenditure are high.

### PROBLEM AND SOLUTION

The problem of the invention is to provide an aforementioned device for determining the temperature of a medium in a duct and an arrangement of a duct with a device, which on the one hand permits a reliable temperature determination and on the other only requires limited effort and expenditure with respect to the use of temperature sensors.

This problem is solved by a device having the features of claim 1 and claim 19. Advantageous and preferred developments of the invention form the subject matter of further claims and will be explained in greater detail hereinafter. By express reference the wording of the claims is made into part of the content of the present description.

According to the invention the device has a probe body with several elongated probe sections. The probe sections extend into the duct and can extend substantially or completely through said duct or its entire cross-section. The temperature sensor for determining the temperature and converting it into a test value is located on the probe body. This arrangement takes place with thermal contact. It can thus be ensured that the temperature sensor determines and passes on the probe body temperature with maximum fidelity.

Through the probe sections, which can be distributed and cover at least part of the duct cross-section or extend into the same, it is possible to determine in distributed manner the temperature over a large cross-sectional surface and by heat conduction in the probe body with the probe sections transfer same to the temperature sensor. This makes it possible to achieve a type of integral temperature determination over at least the duct cross-sectional surface covered by the probe sections and therefore the flowing medium.

The probe sections can be straight and/or parallel to one another. Advantageously they are provided with an equal spacing. It is possible for the probe sections to only run in one direction. This can be advantageous for the manufacture of such a probe body and the probe sections.

In place of roughly equidistant probe sections, as a function of the selected duct or duct cross-section, it is possible to select the spacings of the probe sections in such a way that the flow profile of the medium in the duct is maintained or roughly corresponds to that which would exist without a probe body with probe sections.

Alternatively to probe sections only running in one direction, it is possible for the probe sections to have mutual transverse connections. They can run substantially at right angles to their longitudinal extension from one probe section to another and advantageously the next probe section. This makes it possible to produce a type of grid or net. It is particularly advantageous if the cross connections are constructed in one piece with at least one of the probe sections and in particular all the probe sections.

The probe sections can be constructed in numerous different ways. Advantageously they are rod-like, e.g. elongated fingers. Their cross-section can be rounded or circular. Advantageously the cross-section is substantially constant over their longitudinal extension. This brings about a roughly constant flow profile in the duct and a constant heat conduction in the probe sections. It is possible for the cross-section of the probe sections to be more extensive in the medium flow direction than at right angles thereto. This means a smaller resistance surface against the flowing medium and over the longer lateral faces a good heat or temperature absorption from the flowing medium.

The flow resistance with respect to the flowing medium can be adjusted by means of the spacing of the probe sections. Advantageously the free gaps between two adjacent probe sections are approximately of the order of magnitude of the extension of the probe sections at right angles to the medium flow direction. This means that overall the flowed-through duct cross-sectional surface is roughly as large as the resistance surface formed by the probe sections. It is advantageously possible in this way for the flow cross-section for the medium through the duct or the probe sections to roughly correspond to the total end face of the probe sections in the duct.

The probe sections can run in a continuous surface for maintaining a uniform flow profile in the duct. This surface is advantageously at right angles to the medium flow direction, so that it does not deflect the medium to one duct side, unless this is desired. With particular advantage the surface is a plane. It would also be possible to construct the surface of the probe sections in accordance with the flow profile.

The probe body can have on at least one side a base member from which the probe sections project. This means that the probe body comprises a base member with probe sections projecting therefrom. The base member itself only projects to a very limited extent into the duct. It must firstly not additionally narrow the duct cross-section and this would also influence the temperature approximately uniformly distributed in the probe body as a result of the medium locally flowing past it and consequently the temperature determination would be falsified.

In order to obtain a very good heat conduction of the probe sections with the base member, i.e. within the overall probe body, a connection is advantageously in one piece. With particular advantage the entire probe body is made in one piece, so that interface and surface transitions are avoided to the greatest possible extent. A metal with good conduction is appropriate for the probe sections and preferably also for the base member or the entire probe body. Aluminium or copper are considered to be particularly advantageous. They can be easily worked and also have particularly good heat conducting characteristics. The probe body can be manufactured e.g. by casting, extrusion, etc.

The temperature sensor can be located on the base member. An arrangement roughly in the centre of the base member with respect to the width or cross-section of the duct is particularly appropriate. Thus, the temperature sensor is roughly in the centre of the surface between all the probe sections, which bring about the transfer of the heat from the medium in the duct to the base member.

It is considered advantageous for the temperature sensor to be positioned outside the duct. This once again avoids a falsification at one point by local temperature increases of the medium in the duct.

It is possible to use a duct with a fixed wall with the above-described temperature determination device. The probe body or the entire device can be fixed to the wall or inserted in a corresponding cutout. Thus, fixing is easily and advantageously possible.

If medium flowing in the duct is to be deliberately heated, a heater can be provided. On the basis of forming a module, it can be connected to the device, e.g. to the base member. Thus, only one functional unit has to be fixed to a duct, which simultaneously permits a heating of the medium and the determination of the temperature of the medium. The heater can have a heat transfer member. The latter can be constructed in a similar manner to the probe body or corresponding, conventional heat transfer members. As an alternative to a heater, a medium cooler can be provided in the duct. This is in the same way then provided with a corresponding device.

Advantageously in connection with the above-described module of the probe body, i.e. the temperature determination device, it can be positioned behind the heater in the medium flow direction. Thus, the medium temperature after heating can be measured. This can e.g. be used as a criterion for a temperature control via the heater.

It is possible to construct the temperature sensor as a discreet component. It is possible to have temperature sensors, which are e.g. based on a resistance effect. Alternatively the temperature sensor can be integrated into a heating element, e.g. a thick film element and can be applied therewith.

It is possible to non-detachably fit to the probe body or base member the temperature sensor in order to obtain a very durable and very good heat conducting connection. It can also be advantageous to provide corresponding heat conducting pastes or adhesives.

Thus, through the planar distributed, extended probe body there is a planar or areal temperature determination. By heat conduction in the probe sections or in the probe body a uniform temperature is obtained within the probe body as a result of mutual temperature compensation. Thus, it is possible to measure a temperature at a substantially random point of the probe body which roughly constitutes an averaged or integral temperature representing the average temperature of the overall cross-sectional surface of the duct. Particularly hot or particularly cold points cancel one another out. However, such temperature peaks are not completely lost when determining the overall temperature, but instead pass into the overall temperature corresponding to the planar determined part by means of one or more probe sections. Thus, in particular an average medium temperature can be determined. The average can relate to a temporal and/or spatial distribution.

Thus, in an embodiment of the invention, a device for determining the temperature of a medium flowing through a duct is provided. The device has a probe body with a base member from which project elongated probe arms and extending in the manner of a curtain through the duct. A temperature sensor is located on the probe body. Through the probe arms extending in planar distributed manner over the duct cross-section there is a type of planar, integral temperature determination with temperature averaging. This averaged temperature is measured by means of the temperature sensor. Thus, particularly pronounced local temperature variations of the medium cannot falsify the result of the overall temperature.

These and further features can be gathered from the claims, description and drawings and the individual features, both singly or in the form of subcombinations, can be implemented in an embodiment of the invention and in other fields and can represent advantageous, independently protectable constructions for which protection is claimed here.

### BRIEF DESCRIPTION OF THE DRAWINGS

An embodiment of the invention is described in greater detail hereinafter relative to the attached drawings, wherein show:

FIG. 1 A plan view of a device with a heat transfer member and two determination devices according to the invention located in a duct.

FIG. 2 A side view of the arrangement from FIG. 1.

FIG. 3 A front view of the arrangement from FIG. 1 in the flow direction of the medium in the duct.

### DETAILED DESCRIPTION OF THE EMBODIMENT

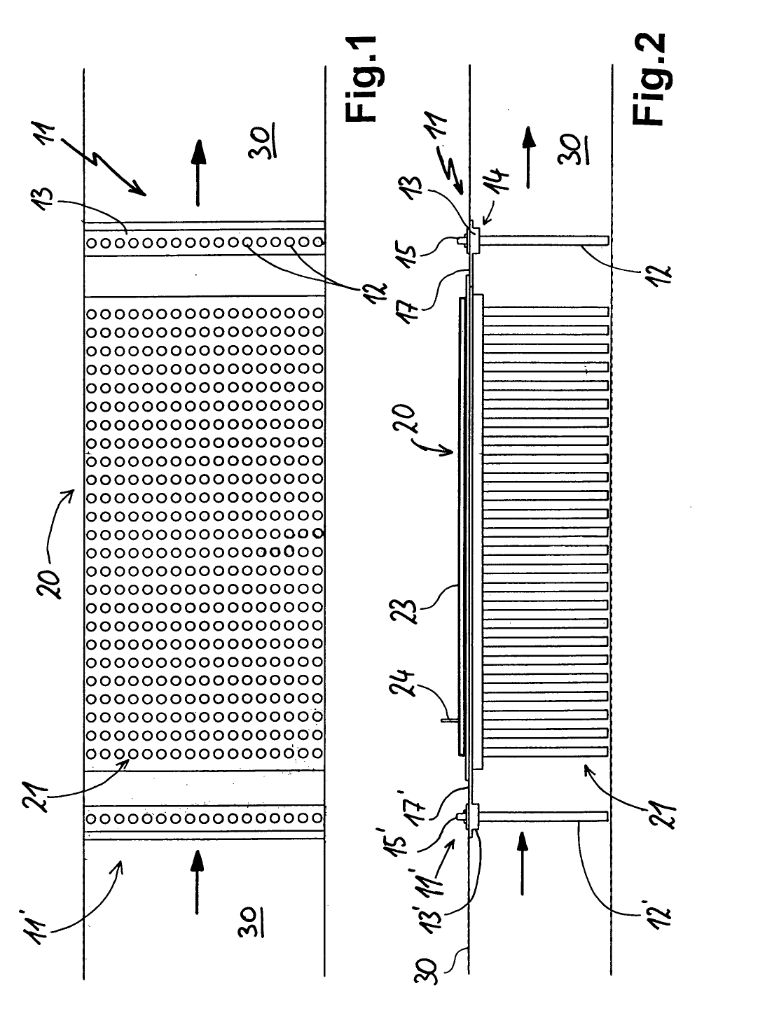

FIG. 1 diagrammatically shows an exemplified, inventive device 11 for determining the temperature of a medium in a duct 30. The device 11 is positioned behind a heater 20 in the medium flow direction from left to right. Upstream of the heater is provided a further device 11′, which substantially corresponds to the device 11. Thus, it is possible to determine the medium temperature in the duct 30 both upstream and downstream of the heater 20. It is thus possible to set a desired medium end temperature. It is also possible to establish the coupled in energy from the temperature difference.

The device 11 has elongated, rod-like probe arms 12 with a round cross-section. They project from the base member 13 and run in parallel and equidistantly to one another. Probe arms 12 and base member 13 form the probe body 14. As can in particular be gathered from FIG. 2, the base member 13 extends into the duct and the medium consequently flows against it at the top of the duct. It is also possible to position the base member 13 outside the duct 30 or outside a duct wall.

The base member 13 supports the temperature sensor 15 on the outside and outside the duct 30. It can be connected in a not shown manner to a control.

It can also be seen how the device 11 with a connecting section 17 is connected to the heater 20 or a heat transfer member 21 of said heater. The probe body 14 or device 11 and heat transfer member 21 or heater 20 are two separate components which are joined together. This has the advantage that as a structural unit they can be more easily handled.

Alternatively to this separate construction it can be seen with regards to the device 11′ upstream of the heater 20 that here the probe body 14 is constructed in one piece with the heat transfer member 21. This can in particular be advantageous for production reasons.

On the outside of the heat transfer member 21, the heater 20 has a planar thick film heater 23. Such thick film heaters are known and need not be explained further here. By means of a terminal 24 the thick film heater 23 or heater 20 is connected to a control. The construction of the heat transfer member 21 with numerous projecting probe arms similar to those of device 11 and 11′ is also known and need not be further illustrated here.

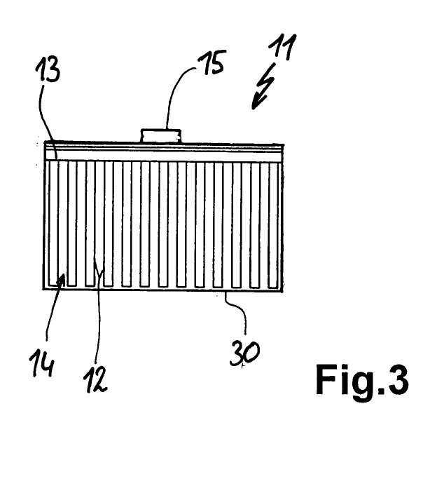

FIG. 3 is a plan view of device 11 or probe body 14 in the medium flow direction and makes it clear that the probe arms 12 roughly take up half the cross-section of duct 30. Thus, as stated hereinbefore, this provides an adequately large flow cross-section for the medium. There is also an adequately good and precise covering of the cross-sectional surface by the probe arms 12 for the aforementioned, integral temperature determination.

In a variant of the invention, it is obviously possible and as stated hereinbefore to construct the probe arms in such a way that they are narrower and closer together. It would also be possible to provide cross connections for a netlike covering. It is also possible, e.g. in the same way as for car radiators, to have a wavy or serpentining path of the probe arms 12.

1. A device for determining the temperature of a flowable medium, wherein said medium flows through a duct with a cross-section, said device having a temperature sensor and a probe body, wherein said probe body has several elongated probe sections, wherein said probe sections extend into said duct, wherein said temperature sensor is arranged on said probe body with thermal contact.

2. A device according to claim 1, wherein said probe sections extend through said entire cross-section of said duct.

3. A device according to claim 1, wherein said probe sections are straight and parallel.

4. A device according to claim 3, wherein said probe sections are equidistant to one another.

5. A device according to claim 1, wherein said probe sections are rod-like.

6. A device according to claim 1, wherein said probe sections are spaced from one another with free gaps, said free gaps between two adjacent of said probe sections being roughly of the order of magnitude of the extension of said probe sections at right angles to a flow direction of said medium.

7. A device according to claim 1, wherein there is a flow cross-section for said medium through said probe sections and said probe sections have an end face in said duct, wherein said flow cross-section is roughly as large as the sum of said end faces of said probe sections in said duct.

8. A device according to claim 1, wherein said probe sections extend in said medium flow direction about the same as at right angles thereto.

9. A device according to claim 1, wherein on one side said probe body has a base member from which said probe sections project and said base member only extends slightly into said duct.

10. A device according to claim 1, wherein said probe sections are connected in one piece with said base member.

11. A device according to claim 10, wherein said probe body of said base member and said probe sections is entirely made in one piece.

12. A device according to claim 1, wherein said temperature sensor is located on said base member.

13. A device according to claim 12, wherein said temperature sensor is placed on said base member outside said duct.

14. A device according to claim 1, wherein said device is connected to a heater.

15. A device according to claim 14, wherein said heater has a heat transfer member extending into said duct.

16. A device according to claim 14, wherein said medium has a flow direction and said probe body is positioned downstream of said heater in said medium flow direction.

17. A device according to claim 1, wherein said temperature sensor is integrated into a heating element.

18. A device according to claim 1, wherein said heating element is a thick film element.

19. An arrangement of a duct with a cross-section for guiding a flowable medium and a device for determining the temperature of said medium, wherein said medium flows through said duct, said device having a temperature sensor and a probe body, wherein said probe body has several elongated probe sections, wherein said probe sections extend into said duct, wherein said temperature sensor is arranged on said probe body with thermal contact.

20. A device according to claim 19, wherein said device is connected to a heater.

21. A device according to claim 20, wherein said heater has a heat transfer member extending into said duct.
